(19) United States
(12) Patent Application Publication
(10) Pub. No.: US 2026/0019385 A1
(43) Pub. Date: Jan. 15, 2026

(54) METHOD FOR PROCESSING AUDIO DATA AND AUDIO DATA PROCESSING SYSTEM

(71) Applicant: REALTEK SEMICONDUCTOR CORP., HSINCHU (TW)

(72) Inventors: WEI-YUAN HSU, HSINCHU (TW); CHIA-WEI YU, HSINCHU (TW)

(21) Appl. No.: 18/989,084

(22) Filed: Dec. 20, 2024

(30) Foreign Application Priority Data
Jul. 9, 2024 (TW) 113125563

(51) Int. Cl. H04L 49/55; H04L 1/00; H04L 49/9057

(52) U.S. Cl. CPC H04L 49/557; H04L 1/0083; H04L 49/555; H04L 49/9057

(57) ABSTRACT

A method for processing audio data and an audio data processing system are provided. The method is operated between a transmitter and a receiver. The transmitter receives audio data, and forms a data set that includes multiple data points. The data points are rearranged in an interlaced manner, and are packetized to form multiple groups of network packets. The network packets are assigned with sequence-identifiable numbers according to a formation sequence. Further, delays can be added in between different groups of the network packets, and then the network packets are rearranged. The multiple groups of the network packets are transmitted to the receiver after data rearrangement, packetization, and packet rearrangement. The receiver then de-packetizes the network packets, and performs data recovery with error handling, so as to generate output audio data.

### CROSS-REFERENCE TO RELATED PATENT APPLICATION

This application claims the benefit of priority to Taiwan Patent Application No. 113125563, filed on Jul. 9, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an audio data processing technology, and more particularly to a method and a system for processing audio data in which packet rearrangement is performed and delays are added in a transmitter to allow a receiver to be properly compensated.

### BACKGROUND OF THE DISCLOSURE

In the process of transmitting audio data within a limited bandwidth, since audio transmission needs to meet a low latency requirement, packets of the audio data to be transmitted to a receiver over a network may be lost.

FIG. 1 is a schematic diagram of a conventional framework of a transmitter 11 and a receiver 12 for transmitting audio data. After the transmitter 11 receives input audio data 111, the input audio data 111 is preprocessed, such as data rearrangement (113). The audio data is rearranged and packetized (115), so as to be converted into network packets. The network packets are then transmitted to the receiver 12 over a network 15. When the receiver 12 receives the network packets, these packets are post-processed, such as packet de-packetization (121) and data recovery (123). After that, output audio data 125 is generated.

In the above-mentioned process, when any data loss is detected in the receiver 12 during the post-processing process, the audio data can be compensated by means of software. The compensation performed on the audio data can reduce staccato and sonic boom that may occur due to data loss. However, when a conventional compensation method for data loss is performed on the receiver 12, the compensation effect is not well since such method still have problems of discontinuous data or jitter sound.

### SUMMARY OF THE DISCLOSURE

In response to the above-referenced technical inadequacies, the present disclosure provides a method for processing audio data and an audio data processing system, so as to improve a compensation effect of the audio data processing system on missing audio data by use of received audio data. In the method for processing the audio data, the continuous audio data is packetized to form multiple groups of network packets in an interlaced manner. The multiple groups of network packets are configured to be set with different delays, so that the multiple groups of network packets can be transmitted at different times. When a receiver sequentially receives the multiple groups of network packets, the missing audio data can be compensated with correct network packets in a data recovery process. The method can therefore achieve a better compensation effect.

In an aspect, the audio data processing system includes a transmitter and the receiver. The method for processing the audio data is performed when the transmitter transmits the received audio data to the receiver via a network.

In the method, the transmitter receives the audio data to form a data set that includes multiple data points. The data points are rearranged in an interlaced manner. The data points are packetized to form multiple groups of network packets. Each of the network packets includes multiple data points having non-consecutive numbers. In the meantime, each of the network packets can be assigned with a sequence-identifiable number according to a formation sequence. The network packets are then rearranged, and the multiple groups of network packets that undergo data rearrangement, packetization, and packet rearrangement are transmitted to the receiver. The multiple groups of network packets are de-packetized and recovered in the receiver, so as to generate output audio data.

Further, in the transmitter, the multiple data points are rearranged for converting sequentially-numbered data points in each of the multiple groups of network packets into the multiple data points having the non-consecutive numbers. After the data rearrangement and the packetization are completed, different groups of the network packets are configured to have different initial packetization delays through the packet rearrangement. Accordingly, the multiple groups of network packets can be transmitted at different times, and time for packet de-packetization in the receiver can be extended. It should be noted that the initial packetization delays are determined according to data-processing capability of the receiver.

Further, after the receiver receives audio data transmitted by the transmitter, the network packets are de-packetized, and the network packets and the multiple data points are sequentially arranged according to numbers of the network packets to be rearranged in the transmitter. Then, the receiver performs data recovery on received data points, and detects the missing audio data during data transmission. The received data points can be used to compensate unreceived data points, and then the compensated data points and the received data points are combined and outputted.

Still further, when the received data points are used to compensate the unreceived data points, an average of values of the multiple data points around missing data points is calculated, and the average is configured as a compensation value for compensating the unreceived data points.

In another aspect of the present disclosure, a filter operation is performed on the received data points around the missing data points, so that the unreceived data points can be compensated.

Further, during the data recovery, an error handling operation is performed on the missing audio data that is unrecoverable, and an interval of the missing audio data is muted in a muting process.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram illustrating a conventional framework of a transmitter and a receiver for transmitting audio data;

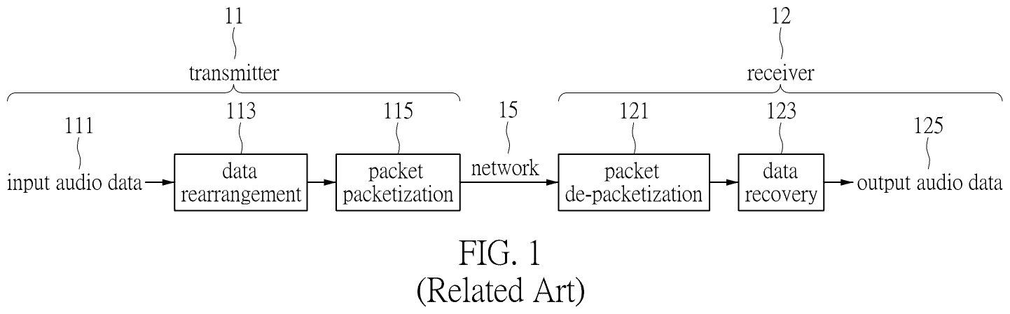

FIG. 2 is a schematic diagram illustrating a framework of an audio data processing system according to one embodiment of the present disclosure;

FIG. 3 is a schematic diagram illustrating data rearrangement in a pre-processing process performed on the audio data in a transmitter according to one embodiment of the present disclosure;

FIG. 4 is a schematic diagram illustrating packetization delay in the pre-processing process performed on the audio data in the transmitter according to one embodiment of the present disclosure;

FIG. 5 is a schematic diagram illustrating packet rearrangement in the pre-processing process performed on the audio data in the transmitter according to one embodiment of the present disclosure;

FIG. 6 is a schematic diagram illustrating the packetization delay in the pre-processing process in the transmitter and a post-processing process in the receiver according to one embodiment of the present disclosure;

FIG. 7 is a schematic diagram illustrating the post-processing process performed on the audio data in the receiver according to one embodiment of the present disclosure;

FIG. 8 is a schematic diagram illustrating data recovery performed in the receiver according one embodiment of the present disclosure;

FIG. 9 is another schematic diagram illustrating the data recovery performed in the receiver according to one embodiment of the present disclosure; and

FIG. 10 and FIG. 11 are data charts showing error handling performed in the receiver according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

The present disclosure relates to a method for processing audio data and an audio data processing system that is operated in a system for transmitting audio data. The audio data processing system includes a transmitter and a receiver. The transmitter is, for example, a data service provider or a specific data processing system that performs a pre-processing process on the audio data. The receiver is, for example, a speaker system that can continuously receive the audio data transmitted by the transmitter in a streaming manner.

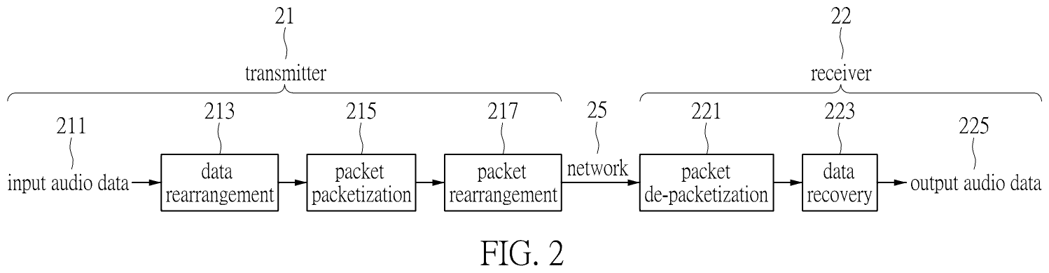

Reference is made to FIG. 2, which is a schematic diagram illustrating a framework of the audio data processing system according to one embodiment of the present disclosure. In addition to circuitry and functions for data transmission and encoding/decoding that are implemented by hardware and software, the diagram shows a flow of the system processing the audio data by processing circuits or firmware.

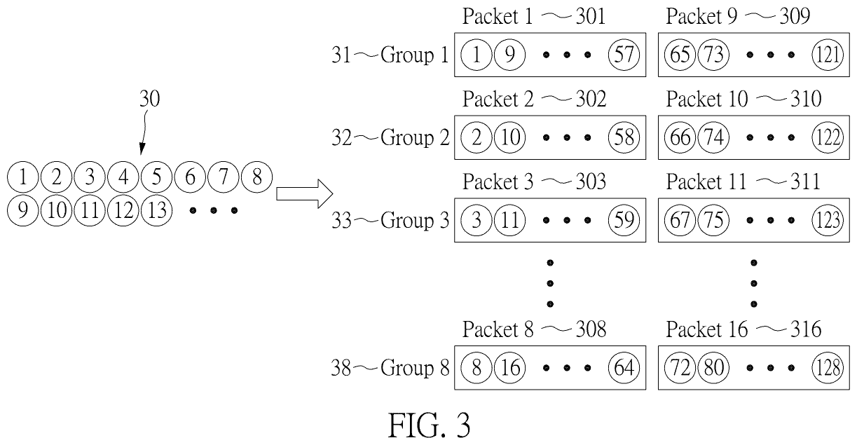

The audio data processing system includes a transmitter 21 and a receiver 22. The transmitter 21 performs a pre-processing process on the audio data, in which the transmitter 21 continuous receives input audio data 211 from a data source and conducts data rearrangement (213) on the input audio data 211. Reference is made to FIG. 3, which is a schematic diagram depicting data rearrangement in the pre-processing process performed on the audio data in the transmitter according to one embodiment of the present disclosure.

In FIG. 3, the transmitter 21 samples a data set 30 composed of multiple data points from the input audio data 211. The data points of the data set 30 are then grouped. As shown in the diagram, the data points are grouped in a specific interlaced manner, so as to form, for example, a first group (Group 1) 31, a second group (Group 2) 32, a third group (Group 3) 33, and up to an eighth group (Group 8) 38. The data points that are originally numbered in a sequential manner in each of the groups of the network packets are converted into the data points with non-consecutive numbers.

In the exemplary diagram, the data points of the data set 30 are divided into eight groups in an interlaced manner, and each of the groups includes eight data points that form a unit. Multiple units are added to different network packets. However, the quantity of the groups, the quantity of the data points in each of the groups, and the numbers shown in the diagram are merely exemplary examples, and are not used to limit the scope of the present disclosure. Further, the quantity of the groups and the quantity of the data points in each of the groups can be adjusted as required.

In this example, after the input audio data is processed with the data rearrangement as described above, the first group (Group 1) 31 includes a first packet (Packet 1) 301 and a ninth packet (Packet 9) 309. The rearranged data points included in the first packet 301 are sequentially numbered 1, 9, and up to 57, and the rearranged data points included in the ninth packet 309 are sequentially numbered 65, 73, and up to 121. The second group (Group 2) 32 includes a second packet (Packet 2) 302 and a tenth group (Packet 10) 310. The rearranged data points included in the second packet 302 are sequentially numbered 2, 10, and up to 58, and the rearranged data points included in the tenth packet 310 are sequentially numbered 66, 74, and up to 122. The third group (Group 3) 33 includes a third packet (Packet 3) 303 and an eleventh packet (Packet 11) 311 that each include the rearranged data points. For example, the rearranged data points of the third packet 303 are sequentially numbered 3, 11, and up to 59, and the rearranged data points of the eleventh packet 311 are sequentially numbered 67, 75, and up to 123. According to the exemplary diagram, the groups of packets are up to the eighth group (Group 8) 38 that includes an eighth packet (Packet 8) 308 and a sixteenth packet (Packet 16) 316. The rearranged data points in the eighth packet 308 are sequentially numbered 8, 16, and up to 64, and the rearranged data points in the sixteenth packet 316 are sequentially numbered 72, 80, and up to 128.

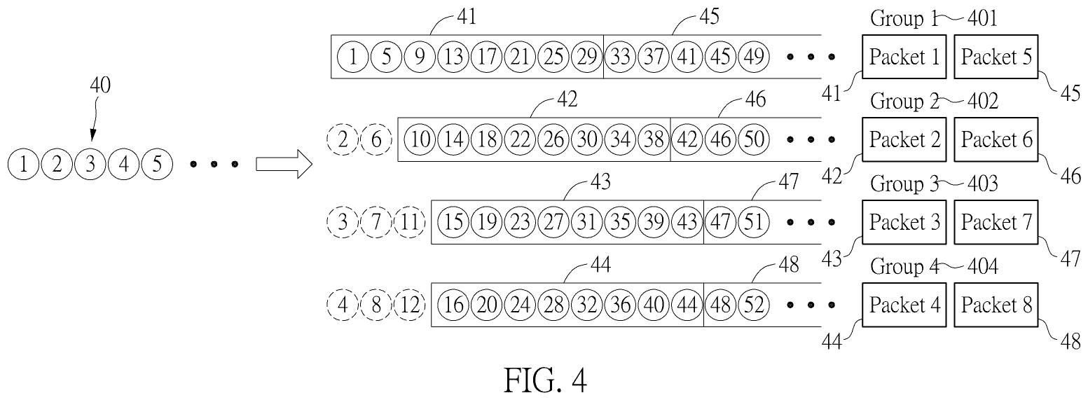

After the data rearrangement shown in FIG. 3, the transmitter 21 of the audio data processing system shown in FIG. 2 continues to perform packetization (215) on the groups of the network packets. During the packetization (215), different groups of the network packets are configured to have different initial packetization delays. Reference is made to FIG. 4, which is a schematic diagram illustrating packetization delays applied to the audio data in the transmitter in the pre-processing process according to one embodiment of the present disclosure. It should be noted that the quantity of the groups and the quantity and the numbers of the data points are merely exemplary examples (which can be adjusted as required), and are not used to limit the scope of the present disclosure.

In FIG. 4, continuous data points of audio data are rearranged to be interlaced data points. Data points of a data set 40 are divided into four groups, and each of the groups includes eight data points that are a unit for formation of a packet. The data set 40 having the multiple data points is schematically divided into a first group (Group 1) 401, a second group (Group 2) 402, a third group (Group 3) 403, and a fourth group (Group 4) 404.

In the diagram, the first group 401 includes a first packet (Packet 1) 41 and a fifth packet (Packet 5) 45. Here, the first packet 41 includes rearranged data points that are sequentially numbered 1, 5, 9, and up to 29, and subsequent data points belong to the fifth packet 45.

Further, the second group 402 includes a second packet (Packet 2) 42 and a sixth packet (Packet 6) 46. In particular, the transmitter 42 performs the packetization 215 for adding packetization delays to the packets in each of groups according to the method for processing the audio data of the present disclosure. As shown in the diagram, as compared to the first packet 41, the second packet 42 is configured to have a packetization delay with two data points. As such, rearranged data points of the second packet 42 are numbered 10, 14, 18, and up to 38 in sequence, and subsequent data points belong to the sixth packet 46.

Further, the third group 403 includes a third packet (Packet 3) 43 and a seventh packet (Packet 7) 47. After applying packetization delays to the packets during the packetization 215, as compared to the first packet 41, the third packet 43 is configured to have a packetization delay with three data points. As such, rearranged data points of the third packet 43 are numbered 15, 19, 23, and up to 43 in sequence, and subsequent data points belong to the seventh packet 47.

The fourth group 404 includes a fourth packet (Packet 4) 44 and an eighth packet (Packet 8) 48. After applying packetization delays to the packets during the packetization 215, as compared to the first packet 41, the fourth packet 44 is configured to have a packetization delay with three data points. As such, rearranged data points of the fourth packet 44 are numbered 16, 20, 24, and up to 44, and subsequent data points belong to the eighth packet 48.

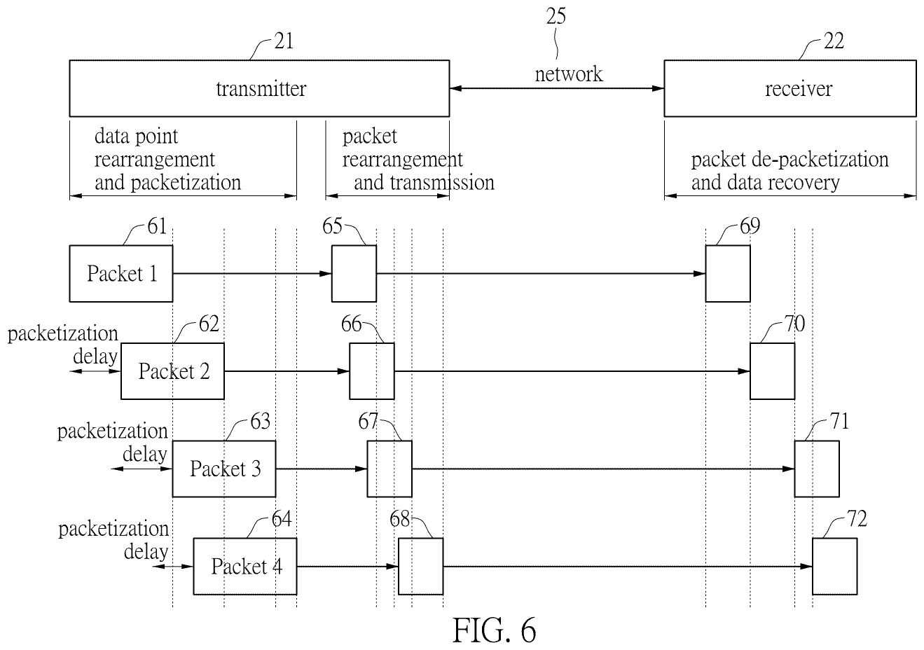

As shown in FIG. 4, when the audio data processing system applies appropriate packetization delays to different groups of the packets, the multiple groups of network packets can be transmitted at different times. Accordingly, when the receiver 22 receives the network packets, the receiver 22 can extend time for de-packetization 221. For relevant description, reference can be made to FIG. 6. It should be noted that, the longer the packetization delay is, the easier the system successfully retransmits the packets due to packet loss during the data transmission (which can reduce the occurrences of data loss). However, in practice, the packetization delay should be appropriately designed as undue delays need to be avoided in actual conditions. For example, the initial packetization delays are determined by taking data-processing capability (such as the size of buffers) of the receiver 22 into consideration.

After the packetization delay shown in FIG. 4, the transmitter 21 of the audio data processing system shown in FIG. 2 continues to perform packet rearrangement 217 on the packetized audio packets. During the packet rearrangement 217, circuits or software of the transmitter 21 assign sequence-identifiable numbers to the network packets that are sequentially generated. Different packetization delays are then applied to the multiple groups of packets, so that a sequence for transmitting the packets is different from a sequence for generating the packets.

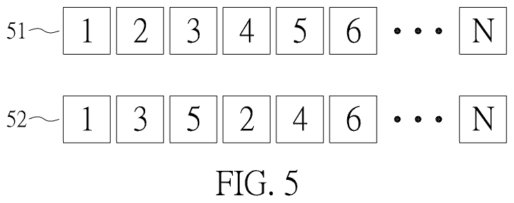

Reference is made to FIG. 5, which is a schematic diagram depicting packet rearrangement in the pre-processing process performed on the audio data in the transmitter according to one embodiment of the present disclosure. A packet sequence 51 indicates a normal sequence of the packets that are numbered 1, 2, and 3 to N. After the packets in the packet sequence 51 are rearranged (213) and packetized (215), the sequence for transmitting the packets will be different from the sequence for generating the packets. Therefore, the network packets to be numbered with the numbers that are not in an original sequence can be assigned with the sequence-identifiable numbers and be rearranged (217). The rearranged network packets can then be added with the packetization delays. The rearranged network packets with the packetization delays are, for example, the packets numbered with 1, 3, and 5 to N in a packet sequence 52.

Further, according to one embodiment of the method for processing the audio data of the present disclosure, in the pre-processing process of the transmitter 21, different groups of the packets are configured to have appropriate packetization delays. One of the objectives of applying the packetization delays to different groups of the packets is to extend the time for de-packetization 221 to be performed on the packets received by the receiver 22. Extension of the time for de-packetization 221 is beneficial for effectively triggering a re-transmission mechanism due to packet loss. Reference is made to FIG. 6, which is a schematic diagram illustrating the pre-processing process with the packetization delay in the transmitter and a post-processing process in the receiver according to one embodiment of the present disclosure.

Referring to FIG. 6, during the data rearrangement and the packetization in the transmitter 212, the packets in the different groups are configured to have different initial packetization delays. For example, as compared to a first packet (Packet 1) 61, a second packet (Packet 2) 62 has a packetization delay in time, and a third packet (Packet 3) 63 is configured to have another packetization delay from one of data points of the first packet 61. Further, a fourth packet (Packet 4) 64 is configured to have a packetization delay. The lengths of the packetization delays applied to different groups of the packets are determined based on practical needs and data-processing capability of the system.

Thus, the delays are added in between the packets before the packets to be transmitted over the network are formed. In the processes of packet rearrangement and transmission, the packets are rearranged as a first rearranged packet 65, a second rearranged packet 66, a third rearranged packet 67, and a fourth rearranged packet 68 as shown in the diagram, and the transmitter 21 will transmit the rearranged packets to the receiver 22 at different times. When the receiver 22 receives the packets over the network 25, the receiver 22 performs packet de-packetization and data recovery. Each of the groups of the packets is shown as a first post-processed packet 69, a second post-processed packet 70, a third post-processed packet 71, and a fourth post-processed packet 72. Since the packets are configured to have the packetization delays in the transmitter 21, the receiver 22 has a sufficient time to handle errors. Accordingly, the receiver 22 will not have the problem of packet loss due to insufficient hardware processing capabilities.

As shown in FIG. 2, after the audio data completely undergoes the data rearrangement (213), the packetization (215), and the packet rearrangement (217) in the transmitter 21, the rearranged packets are transmitted to the receiver 22, and the receiver 22 performs the post-processing process on the received packets by a processing circuit or firmware. In the receiver 22, the received packets undergo the de-packetization (221) and data recovery (223), and output audio data 225 is generated.

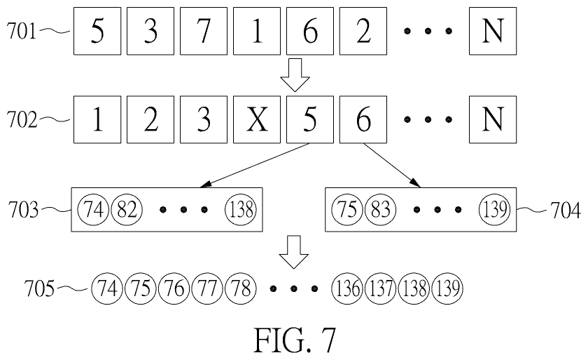

The de-packetization (221) is performed in the receiver 22 for de-packetizing the received packets, in which the numbers assigned to the packets through the packet rearrangement (217) in the transmitter 21 are referred to for arranging the packets in sequence. Reference is made to FIG. 7, which is a schematic diagram illustrating the post-processing process performed on the audio data in the receiver according to one embodiment of the present disclosure.

FIG. 7 shows a packet sequence 701 received by the receiver 22. The packet sequence 701 is schematically illustrated by a sequence of packets numbered 5, 3, and 7 to N that are not the original sequence of the packets. Next, the packets are arranged according to the numbers of the packets, so as to obtain a packet sequence 702 in which the packets are numbered 1, 2, and 3 to N.

In the packet sequence 702 having the sequentially-arranged packets, a packet number 5 can be de-packetized to obtain data points 703 of a fifth packet (Packet 5) that is rearranged in the transmitter 21, and a packet number 6 can be de-packetized to obtain data points 704 of a sixth packet (Packet 6) that is also rearranged in the transmitter 21 (as shown in the schematic diagram). Next, the data points are arranged according to a sequence of the data points, so as to obtain data points 705 that are arranged in a correct sequence before the data rearrangement is performed by the transmitter 21.

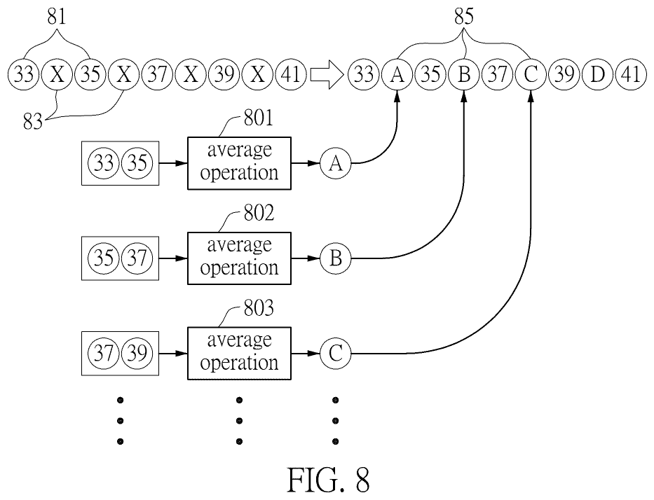

When the packets are completely de-packetized, the receiver 22 performs the data recovery (223). Reference is next made to FIG. 8.

In the schematic diagram of FIG. 8, the data received by a receiver includes received data points 81. However, missing audio data (e.g., unreceived data points 83) during the data transmission can be detected based on correlation between previous and subsequent data points. The received data points 81 are referred to for compensating the unreceived data points 83 that are labeled as “X.” Afterwards, the compensated data points and the received data point 81 are combined and outputted as recovered data points 85.

FIG. 8 exemplarily shows use of an average operation to compensate the unreceived data points. Firstly, the values of the multiple data points around the missing data points are averaged, so as to obtain the compensation data for compensating the unreceived data points. The compensated unreceived data points are combined with the other correct data points to form output data points. In an exemplary example, an unreceived data point “X” is positioned between the data point No. 33 and the data point No. 35. The value of the data point “X” is calculated by an average operation 801 between the values of the data point No. 33 and the data point No. 35, so as to obtain a compensated data point A. Similarly, the values of the data point No. 35 and the data point No. 37 are operated through an average operation 802 for calculating a value of the data point between the data point No. 35 and the data point No. 37, so as to obtain a compensated data point B. Further, the values of the data point No. 37 and the data point No. 39 are operated through an average operation 803 for calculating a value of the data point between the data point No. 37 and the data point No. 39, so as to obtain a compensated data point C. The unreceived data point 83 can be completely compensated by repeating the above steps, so as to obtain the recovered data point 85.

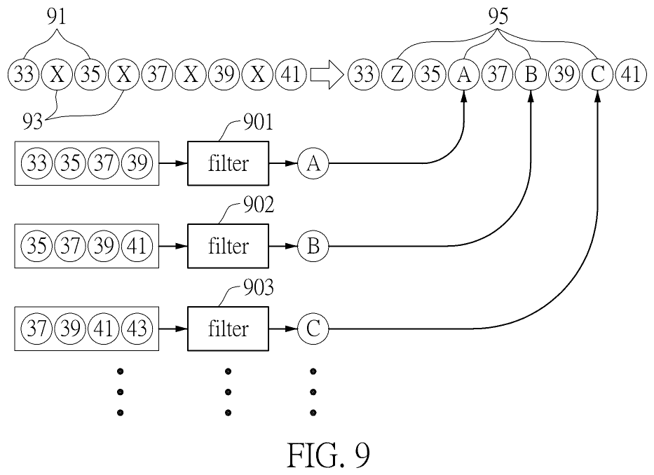

Another compensation solution for the data recovery is to use a filter. Reference is made to FIG. 9, which is another schematic diagram illustrating the data recovery performed in the receiver according to one embodiment of the present disclosure. The receiver receives data having a limited length (such as received data points 91), and determines that there are missing data points (such as unreceived data points 93) during the data transmission. After that, the filter with a specific length can be used to generate the compensation data for the data points covered by the filter.

The filter can be a digital filter that is designed based on an arrangement rule for the data and the information of a header (e.g., a time sequence) of the network packets. Therefore, the filter can be used to filter digital signals of missing data. In an exemplary example shown in the diagram, several filters 901, 902, and 903 with a length of 4 are used in the receiver. The filter 901 receives multiple adjacent data points that are numbered 33, 35, 37, and 39. One of the unreceived data points 93 can be compensated by the filter 901 that is performed for obtaining a compensated data point A. Similarly, the filter 902 is used to filter the other four data points numbered 35, 37, 39, and 41, so as to compensate one of the unreceived data points 93 and obtain a compensated data point B. Further, the filter 903 is used to filter the four data points numbered 37. 39, 41, and 43, so as to obtain a compensated data point C.

When the compensated data points A, B, and C are obtained by the filters 901, 902, and 903, the compensated data points are then added to corresponding positions and combined with the received data points 91, so as to form output data. The unreceived data points 93 are completely compensated by repeating the above steps, so as to obtain recovered data points 95.

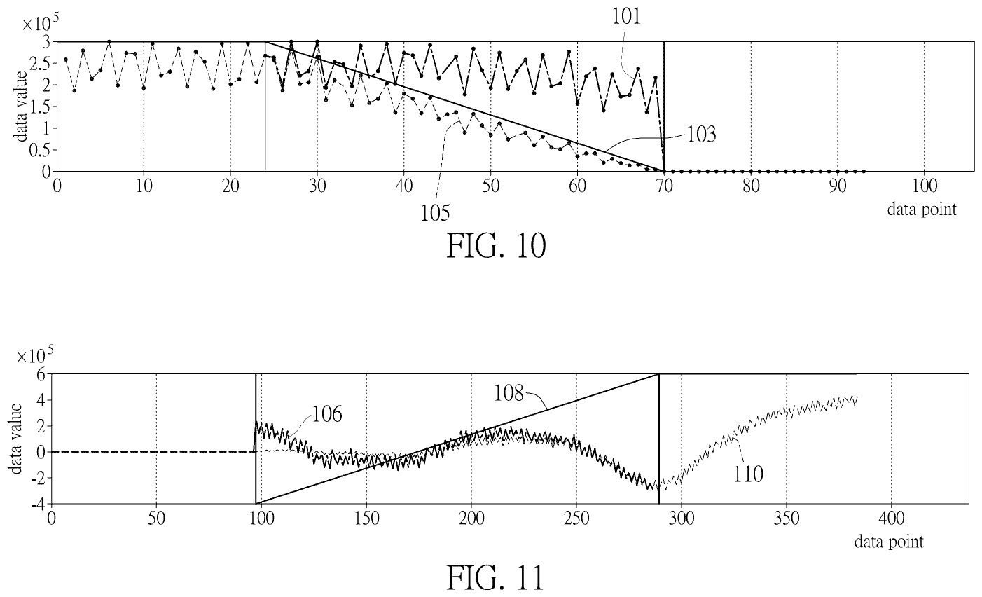

During the data recovery, the system may still detect the missing audio data that cannot be recovered. The unrecoverable data may be one or more data points. When the system determines that the data cannot be compensated through the data recovery, the system performs an error handling operation on the unrecoverable data. For example, a muting process is performed on an interval of the missing audio data. Reference can be made to FIG. 10 and FIG. 11, which show embodiments of the error handling operation.

One of the approaches of error handling is to conduct mute processing on the missing data, so as to form a mute interval when the missing data is muted in the muting process. In particular, before the mute interval is formed in the muting process, the audio data in a previous interval is multiplied by a decreasing gain and then connected with the mute interval. A decreasing rate of the decreasing gain and an interval length for the mute processing can be adjusted as required. Reference is made to FIG. 10, which is a data chart showing error handling performed in the receiver according to one embodiment of the present disclosure.

FIG. 10 shows original audio data 101 in a chart. An interval of data with a length of 46 is selected according to the present example. The data of from a data point 24 to a data point 70 has an interval with a decreasing gain, and therefore a decreasing gain 103 from 1 descended to 0 is provided. Before the mute interval, the original audio data 101 is multiplied by the decreasing gain 103, and data 105 that is processed with the decreasing gain 103 is obtained. The corrected data is then connected with subsequent data in the muted interval.

In continuation of the above embodiment, when the receiver receives the audio data in the mute interval, the audio data in a next interval is multiplied by an increasing gain after the mute interval. The audio data that is multiplied by the increasing gain in the next interval is connected with the following received audio data (i.e., the data points). Similarly, an increasing rate of the increasing gain and an interval length can be adjusted as required.

FIG. 11 shows another data chart depicting error handling operation performed in the receiver. Original audio data 106 with an increasing gain 108 from 0 increased to 1 is provided in the data chart. An interval of the increasing gain 108 covers 192 data points, such as an interval with the increasing gain from a data point 95 to a data point 287. The original audio data 106 is multiplied by the increasing gain 108 with a length of 192 data points, so as to obtain data 110 that is processed with the increasing gain 108. The corrected data 110 is then connected with the original audio data 106. Accordingly, the error handling operation is accomplished.

In conclusion, according to the above embodiments of the method for processing the audio data and the audio data processing system, the transmitter performs a pre-processing process for packetizing audio data in an interlaced manner, so as to obtain multiple groups of network packets. Different initial packetization delays are applied in between the multiple groups of the network packets, so that the network packets can be transmitted at different times due to the delays. The network packets are then de-packetized and rearranged according to a sequence of data points in the receiver. If any missing packet is detected, the correctly received data can be used to compensate the missing packet. A better compensation result can be achieved.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for processing audio data, which is operated in a system that includes a transmitter and a receiver, the method comprising:
receiving, in the transmitter, audio data to form a data set that includes multiple data points;
performing data rearrangement to rearrange the multiple data points in an interlaced manner, and forming multiple groups of network packets after packetization of the rearranged data points, wherein each of the multiple groups of the network packets includes multiple data points having non-consecutive numbers, and each of the network packets is assigned with a sequence-identifiable number according to a formation sequence of packets;
performing packet rearrangement on the multiple groups of the network packets; and
transmitting the multiple groups of the network packets that undergo the data rearrangement, the packetization, and the packet rearrangement to the receiver, and de-packetizing and recovering the multiple groups of the network packets in the receiver for generating output audio data.

2. The method according to claim 1, wherein, after the receiver receives audio data transmitted by the transmitter, the network packets are de-packetized, and the network packets and the multiple data points are sequentially arranged according to numbers of the network packets to be rearranged in the transmitter.

3. The method according to claim 1, wherein, in the transmitter, the multiple data points are obtained by sampling the audio data, and the multiple data points are rearranged for converting sequentially-numbered data points in each of the multiple groups of network packets into the multiple data points having the non-consecutive numbers.

4. The method according to claim 3, wherein, in the transmitter, after the data rearrangement and the packetization are accomplished, different groups of the network packets are configured to have different initial packetization delays through the packet rearrangement, so that the multiple groups of network packets are transmitted at different times for extending time for de-packetization in the receiver.

5. The method according to claim 4, wherein the initial packetization delays are determined according to data-processing capability of the receiver.

6. The method according to claim 5, wherein, after the receiver receives audio data transmitted by the transmitter, the network packets are de-packetized, and the network packets and the multiple data points are sequentially arranged according to numbers of the network packets to be rearranged in the transmitter.

7. The method according to claim 6, wherein, when the receiver performs data recovery, received data points are obtained and used to detect missing data during data transmission, so that the received data points are used to compensate unreceived data points, and the compensated data points and the received data points are combined and outputted.

8. The method according to claim 7, wherein, when the received data points are used to compensate the unreceived data points, an average of values of the multiple data points around the missing data is calculated, and the average is configured as a compensation value for compensating the unreceived data points.

9. The method according to claim 7, wherein a filter operation is used to process the received data points around the missing data, so as to compensate the unreceived data points.

10. The method according to claim 7, wherein, during the data recovery, an error handling operation is performed on missing audio data that is unrecoverable, and an interval of the missing audio data is muted in a muting process.

11. The method according to claim 10, wherein, before a mute interval is formed in the muting process, the audio data in a previous interval is multiplied by a decreasing gain, and then is connected with the mute interval; wherein, after the mute interval, the audio data in a next interval is multiplied by an increasing gain, and then is connected with subsequently received data points.

12. An audio data processing system, comprising:
a transmitter and a receiver, wherein the transmitter transmits received audio data to the receiver via a network; wherein a method for processing audio data is performed in the transmitter, and the method comprises:
receiving, in the transmitter, audio data to form a data set that includes multiple data points;
performing data rearrangement to rearrange the multiple data points in an interlaced manner, and forming multiple groups of network packets after packetization of the rearranged data points, wherein each of the multiple groups of the network packets includes multiple data points having non-consecutive numbers, and each of the network packets is assigned with a sequence-identifiable number according to a formation sequence of packets;
performing packet rearrangement on the multiple groups of network packets; and
transmitting the multiple groups of the network packets that undergo the data rearrangement, the packetization and the packet rearrangement to the receiver, and de-packetizing and recovering the multiple groups of the network packets in the receiver for generating output audio data.

13. The audio data processing system according to claim 12, wherein, after the receiver receives audio data transmitted by the transmitter, the network packets are de-packetized, and the network packets and the multiple data points are sequentially arranged according to numbers of the network packets to be rearranged in the transmitter; wherein, when the receiver performs data recovery, received data points are obtained and used to detect missing audio data during data transmission, so that the received data points are used to compensate unreceived data points, and the compensated data points and the received data points are combined and outputted.

14. The audio data processing system according to claim 12, wherein, in the transmitter, the multiple data points are obtained by sampling the audio data, and the multiple data points are rearranged for converting sequentially-numbered data points in each of the multiple groups of network packets into the multiple data points having the non-consecutive numbers.

15. The audio data processing system according to claim 14, wherein, in the transmitter, after the data rearrangement and the packetization are accomplished, different groups of the network packets are configured to have different initial packetization delays through the packet rearrangement, so that the multiple groups of network packets are transmitted at different times for extending time for de-packetization in the receiver; wherein the initial packetization delays are determined according to data-processing capability of the receiver.

16. The audio data processing system according to claim 15, wherein, after the receiver receives the audio data transmitted by the transmitter, the network packets are de-packetized, and the network packets and the multiple data points are sequentially arranged according to numbers of the network packets to be rearranged in the transmitter; wherein, when the receiver performs data recovery, received data points are obtained and used to detect missing audio data during data transmission, so that the received data points are used to compensate unreceived data points, and the compensated data points and the received data points are combined and outputted.

17. The audio data processing system according to claim 16, wherein, when the received data points are used to compensate the unreceived data points, an average of values of the multiple data points around the missing data is calculated, and the average is configured as a compensation value for compensating the unreceived data points.

18. The audio data processing system according to claim 16, wherein a filter operation is used to process the received data points around missing data, so as to compensate the unreceived data points.

19. The audio data processing system according to claim 16, wherein, during the data recovery, an error handling operation is performed on the missing audio data that is unrecoverable, and an interval of the missing audio data is muted in a muting process.

20. The audio data processing system according to claim 19, wherein, before a mute interval is formed in the muting process, the audio data in a previous interval is multiplied by a decreasing gain, and then is connected with the mute interval; wherein, after the mute interval, the audio data in a next interval is multiplied by an increasing gain, and then is connected with subsequently received data points.
